(19) United States
(12) Patent Application Publication
(10) Pub. No.: US 2011/0241891 A1
(43) Pub. Date: Oct. 6, 2011

(54) GROUND FAULT INDICATOR

(75) Inventor: Song-Lin Tong, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/777,283

(22) Filed: May 11, 2010

(30) Foreign Application Priority Data
Mar. 31, 2010 (CN) 201010137016.9

(51) Int. Cl. G08B 21/18

(52) U.S. Cl. 340/650; 340/3.43

(57) ABSTRACT

A constant current source, a measurement unit, an indication unit, and a controller are provided. The constant current source is connected to a shell of an electric device and configured to supply a constant current to the shell. The shell is connected to a ground line terminal of a power supply to which the electric device is connected. The measurement unit is configured for measuring a first voltage of the ground line terminal and a voltage between the shell and the ground line terminal. The controller is configured for controlling the indication unit to give warnings either when the first voltage is zero or when the second voltage is higher than a preset value.

### BACKGROUND

1. Technical Field

The present disclosure relates to ground fault indicators and, particularly, to a ground fault indicator for giving warnings if a shell of an electric device is improperly grounded.

2. Description of Related Art

Ground fault interrupters are employed to interrupt household or factory circuits when a difference of currents flowing through a live line and a neutral line of a power supply is higher than a preset value, e.g., about 5 mA. A difference in currents might also be caused when the current of the live line leaks into a ground line of the power supply due to short circuits. In such a case, if the shell of an electric device is improperly grounded, the ground fault interrupter can detect the fault and interrupt the circuit. However, the ground fault interrupter may become unreliable over time. As such, the ground fault interrupter may fail to interrupt the circuit even though the difference of the currents is detected, which may cause fatal accidents. Also, a conventional ground fault interrupter cannot detect static charges accumulated on the shell which may cause electrical shocks too when the shell is improperly grounded.

Therefore, it is desirable to provide a ground fault indicator, which can overcome the above-mentioned limitations.

### BRIEF DESCRIPTION OF THE DRAWINGS

Many aspects of the present ground fault indicator should be better understood with reference to the following drawings. The components in the drawings are not necessarily drawn to scale, the emphasis instead being placed upon clearly illustrating the principles of the present ground fault indicator. Moreover, in the drawings, like reference numerals designate corresponding parts throughout the several views.

FIG. 1 is a block diagram of a ground fault indicator, according to one embodiment.

FIG. 2 is an isometric schematic of the ground fault indicator, according to another embodiment.

FIG. 3 is a block diagram of the ground fault indicator of FIG. 2.

### DETAILED DESCRIPTION

Embodiments of the present ground fault indicator will now be described in detail with reference to the drawings.

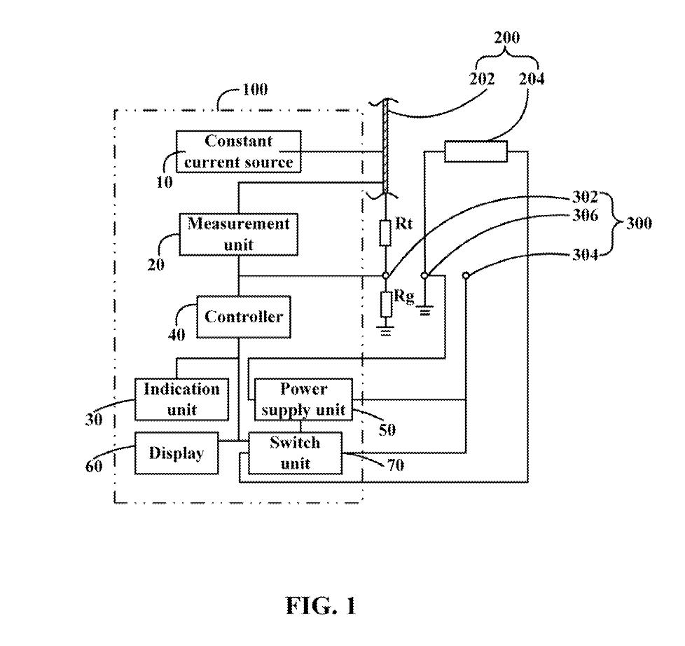

Referring to FIG. 1, an ground fault indicator 100, according to an embodiment, is configured for detecting whether a shell 202 of an electric device 200 is properly connected to a ground line terminal 302 of a local power supply 300 to which the electric device 200 is connected and giving warnings if the shell 202 is improperly connected to the ground line terminal 302.

The electrical device 200 can be any of a variety of household or industrial appliances and includes a power consumption section housed in the shell 202, which is illustrated as a consumption resistor 204 in FIG. 1.

In addition to the ground line terminal 302, the local power supply 300 generally includes a live line terminal 304 and a neutral line terminal 306. The ground line terminal 302 and the neutral line terminal 306 are grounded. However, due to contact resistance, a resistance between the ground line terminal 302 and earth is not exactly zero but can be embodied as a resistor Rg having a relatively small resistance (typically less than 100Ω). A voltage of the live line terminal 304 is about 220V alternating current (AC). However, in different countries/regions or for specific applications, the voltage of the live line terminal 302 can be different.

In use, the consumption resistor 204 (the power consumption section of the electric device 200) is connected between the live line terminal 304 and the neutral line terminal 306 for drawing power from the local power supply 300, and the shell 202 is connected to the ground line terminal 302 to allow electrical charges accumulated on the shell 202 to discharge to earth. The charges on the shell 202 may be static charges or come from the local power supply 300 through the live line (not labeled) due to short circuits. If the shell 202 is faultily connected to the ground line terminal 302, the electric charges on the shell 202 cannot be discharged to earth and might cause electrical accidents when users touch the shell 20, such as a discharging current flowing through the user to earth.

Due to contact resistance, even if the shell 202 is properly connected to the ground line terminal 302, the resistance between the shell 302 and the ground line terminal 302 is not exactly zero but can be embodied as a resistor Rt having a relatively small resistance (typically less than 100Ω) too. Generally, when the resistance between the shell 202 and the earth (i.e., Rg+Rt) is less than 100Ω, it is deemed that the shell 202 is properly grounded.

The ground fault indicator 100 includes a constant current source 10, a measurement unit 20, an indication unit 30, a controller 40, and a power supply unit 50.

The constant current source 10 is connected to the shell 202 and configured for supplying a constant current to the shell 202. The constant current in this embodiment is set to about 10 mA to ensure safe usage of the ground fault indicator 100.

The measurement unit 20 is configured for measuring a first voltage of the ground line terminal 302. If the measured first voltage is zero, it is determined that the shell 202 is disconnected from the ground line terminal 302 since the constant current does not flow to the ground line terminal 302. Otherwise, the first voltage would not be zero and would be equal to I*Rg, where I is the value of the constant current. In addition, the measurement unit 20 is also used to measure a second voltage between the shell 202 and the ground line terminal 302. If the measured second voltage is higher than a preset value, it is determined that the shell 202 is not well connected to the ground line terminal 302. Otherwise, as explained above, the second voltage would be a relatively low value of about, e.g., 0.1V (i.e., I*Rt=10 mA*10Ω=0.1V). As such, the preset value can be set to 0.1V but can be set to other values depending on requirements in other alternative embodiments.

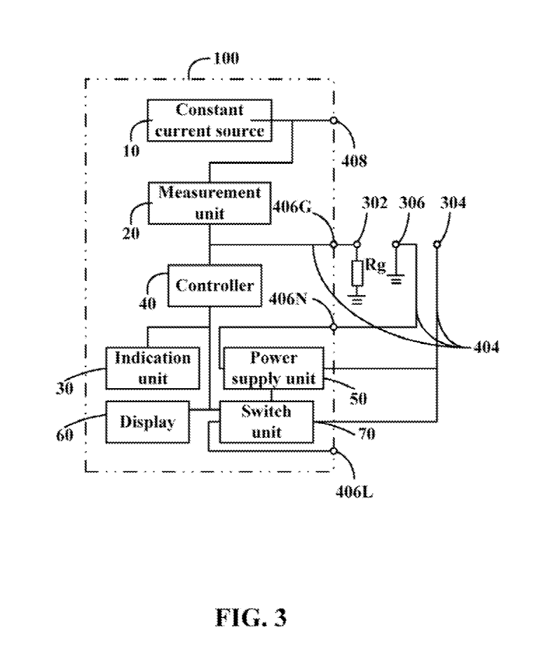

The indication unit 30 can be a light emitting diode 32, a buzzer 34 (see FIG. 3), or both. Alternatively, the ground fault indicator 100 can further includes a display 60, such as liquid crystal display (LCD) for displaying more detail information of the measurement of the measurement unit 20, such as the measured voltages and the calculated resistance Rt.

The controller 40 is configured for controlling the indication unit 30 to alarm, for example, turning on or off the LED 32 or the buzzer 34 or driving the LED 32 to flicker, when the shell 202 is disconnected from or not well connected to the ground line terminal 302 (i.e., the first voltage is zero or the second voltage is higher than the preset value).

The power supply unit 50 is connected between the live line terminal 304 and the neutral line terminal 306 for converting the voltage of the live line terminal 304 into a working voltage of the ground fault indicator 100 and thus supply power for the constant current source 10, the measurement unit 20, the indication unit 30, the controller 40, and display 60.

Alternatively, the ground fault indicator 100 may also include a switch unit 70. The switch unit 70 is connected with a consumption resistor 204 in series between the live line terminal 304 and the neutral line terminal 306. The consumption resistor 204 is connected to the live line terminal 304 through the switch unit 70. The controller 40 is also configured for turning off the switch unit 70 when the shell 202 is disconnected from or not well connected to the ground line terminal 302 and otherwise turning on the switch unit 70. When the switch unit 70 is turned off, the connection between the consumption resistor 204 and the live line terminal 304 is broken. In this embodiment, the switch unit 70 is a relay.

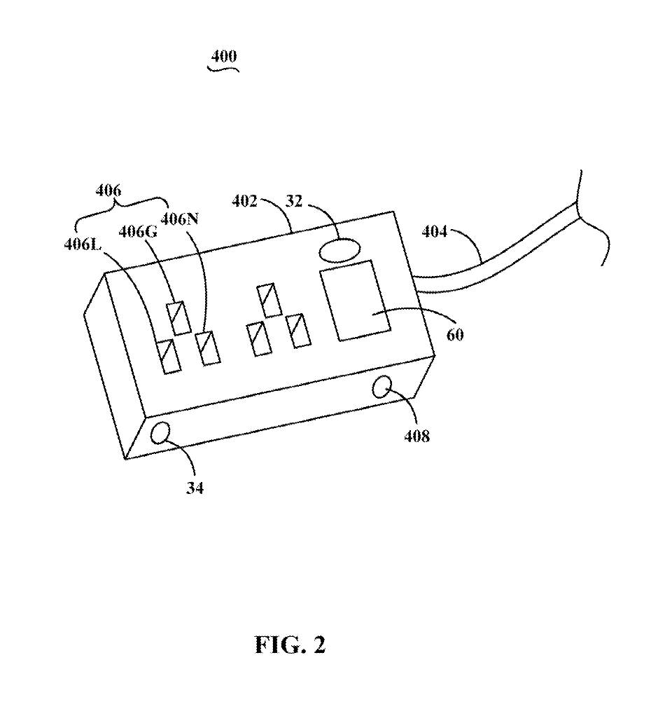

Referring to FIGS. 2-3, another ground fault indicator 400, according to another embodiment, is a power strip as illustrated in FIG. 2 and includes a body 402, a cable 404, and the alarm deice 100.

The body 402 has but not limited to two sockets 406. Each socket 406 includes a ground contact 406G, a live contact 406L, and a neutral contact 406N. The ground contact 406G, the live contact 406L, and the neutral contact 406N are connected to the ground line terminal 302, the live line terminal 304, and the neutral line terminal 306, respectively. The electric device 200 is connected to the local power supply 300 by plugging a plug of a cable of the electric device into one of the sockets 406. The constant current source 10, the measurement unit 20, the controller 40, and the power supply unit 50, and the switch unit 70 are housed within the body 402. The LED 32, the buzzer 34, and the display 60 are mounted on the body 402.

The ground fault indicator 400 also includes a connecting port 408. The connecting port 408 is formed on the body 402 and is connected to the constant current source 10 and the measurement unit 20. As such, the constant current source 10 and the measurement unit 20 can be connected to the shell 202 by a wire (not shown) which connects the connecting port 408 to the shell 202.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A ground fault indicator comprising:
a constant current source connected to a shell of an electric device and configured to supply a constant current to the shell; the shell being connected to a ground line terminal of a power supply to which the electric device is connected;
a measurement unit configured for measuring a first voltage of the ground line terminal and a voltage between the shell and the ground line terminal;
an indication unit; and
a controller configured for controlling the indication unit to give warnings either when the first voltage is zero or when the second voltage is higher than a preset value.

2. The ground fault indicator of claim 1, wherein the constant current is about 10 mA direct current.

3. The ground fault indicator of claim 1, wherein the indication unit is selected from the group consisting of a light emitting diode and a buzzer.

4. The ground fault indicator of claim 3, wherein the controller is configured for turning on or off the light emitting diode or the buzzer to give warnings.

5. The ground fault indicator of claim 3, wherein the controller is configured for driving the light emitting diode to flicker as to give warnings.

6. The ground fault indicator of claim 1, wherein the preset value is about 0.1V.

7. The ground fault indicator of claim 1, further comprising a display; the display being configured for displaying the first voltage and the second voltage.

8. The ground fault indicator of claim 1, further comprising a switch unit; the power supply further comprising a live line terminal; the electric device being connected to the live line terminal through the switch unit for obtaining power; the controller being configured for turning off the switch unit either when the first voltage is zero or when the second voltage is higher than the preset value to break a connection between the live line terminal and the electric device.

9. The ground fault indicator of claim 8, wherein the switch unit is a relay.

10. The ground fault indicator of claim 1, wherein the ground fault indicator is a power strip and further comprises a body and a cable; the body comprising a socket; the socket comprising a ground contact, a live contact, and a neutral contact; the ground contact, the live contact, and the neutral contact being connected to the ground line terminal, a live line terminal of the power supply, and a neutral line terminal of the power supply via the cable, respectively; the constant current source, the measurement unit, and the controller being housed in the body; the indication unit being mounted on the body.

11. The ground fault indicator of claim 10, wherein the constant current is about 10 mA direct current.

12. The ground fault indicator of claim 10, wherein the indication unit comprises a light emitting diode and a buzzer; the light emitting diode and the buzzer being mounted on the body.

13. The ground fault indicator of claim 12, wherein the controller is configured for turning on or off the light emitting diode or the buzzer to give warnings.

14. The ground fault indicator of claim 12, wherein the controller is configured for driving the light emitting diode to flicker to give warnings.

15. The ground fault indicator of claim 10, wherein the preset value is about 0.1V.

16. The ground fault indicator of claim 10, further comprising a display; the display being mounted on the body and configured for displaying the first voltage and the second voltage.

17. The ground fault indicator of claim 10, further comprising a switch unit; the power supply further comprising a live line terminal; the electric device being connected to the live line terminal through the switch unit for obtaining power; the controller being configured for turning off the switch unit either when the first voltage is zero or when the second voltage is higher than the preset value to break a connection between the live line terminal and the electric device.

18. The ground fault indicator of claim 17, wherein the switch unit is a relay.

19. The ground fault indicator of claim 10, further comprising a connecting port; the connecting port being formed on the body and connected to the constant current source and the measurement unit; the connecting port allowing a wire inserting therein and thus connected to the shell via the wire.
